(19) United States
(12) Patent Application Publication
(10) Pub. No.: US 2003/0167412 A1
(43) Pub. Date: Sep. 4, 2003

(54) Network identity mark issuance/management system, apparatus, method and recording medium containing program therefor

(75) Inventors: Chikara Takauji, Tokyo (JP); Shinichi Takahashi, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/373,111

(22) Filed: Feb. 26, 2003

(30) Foreign Application Priority Data
Mar. 1, 2002 (JP) 055444/2002

(51) Int. Cl. G06F 12/14

(52) U.S. Cl. 713/201

(57) ABSTRACT

This invention provides a network identity mark issuance/management system which can readily assure credibility of information and credibility in business in virtual worlds such as the Internet world. Upon receiving NIM issuance application information sent out by an applicant from a user terminal, an NIM issuance/management apparatus extracts user IDs registered with NIM authentication terminals from the NIM issuance application information and sends out the appropriate user ID and an authentication request to each of the NIM authentication terminals. When examination result information is received from the NIM authentication terminals in response to the authentication request and if the examination results are “accept,” the NIM issuance/management apparatus issues an NIM and sends it out to the user terminal. The user terminal receives the NIM issued by the NIM issuance/management apparatus via a network and retains it.

### BACKGROUND OF THE INVENTION

1. Field of the Invention

The present invention relates to a network identity mark issuance/management system, issuance/management apparatus used therefor, and method therefor. More particularly, it relates to user identification in virtual worlds such as the Internet.

2. Description of the Prior Art

Recently, virtual worlds such as communities, shopping malls, and electronic bulletin boards which simulate real worlds have been constructed in storage devices of host servers (computers) connected to the Internet or the like.

People who access such a virtual world transmit information and do business, for example, chat with each other as people with a virtual personality, enjoy shopping, and so forth within the virtual world.

Although conventional virtual worlds such as those described above have the advantage of allowing anyone to transmit information freely on an anonymous basis, they have the problem that they are inferior to other media in terms of information credibility because it is not clear how accurate published information is or what is the profile of the person who is transmitting the information.

Similarly, in business activities such as shopping in a shopping mall or Net auction, it is difficult to verify whether a purchaser is a person himself, whether he is credible, whether a credit card or the like is not a stolen one, etc.

Also, it is not possible to tell whether electronic mail received from a stranger is genuine or a falsehood intended to be a chain letter. For example,it is difficult to verify whether, an emergency evacuation order resulting from an announcement of a terrorist attack or a disaster, a call for blood donors to help an emergency patient, or the like is true.

Besides, it is not possible to tell whether articles in homepages on Web sites are true. For example, it is difficult to verify the truth of business information which will affect stock prices posted by a self-styled financial analyst as well as the truth of celebrity gossip, a fund-raising activity led by one individual, or the like.

Furthermore, it is not possible to tell whether qualifications proclaimed on home pages are genuine. For example, if someone who provides Internet counseling claims to be qualified as a counselor, it is difficult to verify whether his/her claim is true.

Thus, an object of the present invention is to solve the above problems and provide a network identity mark issuance/management system, issuance/management apparatus used therefor, and method therefor, which can readily assure credibility of information and credibility in business in virtual worlds such as the Internet world.

### SUMMARY OF THE INVENTION

A network identity mark issuance/management system according to the present invention manages attributes corresponding to user identifiers which are given to individual users and identify the users, and identification information which is given to the attributes and identifies the attributes, in a virtual world which exists in a storage device of a computer connected to at least the Internet.

Another network identity mark issuance/management system according to the present invention comprises authentication terminals each of which is provided for each of a plurality of virtual worlds existing in a storage device of a computer connected to at least the Internet and authenticates attributes that correspond to users who use the virtual worlds; and

an issuance/management apparatus for collecting the attributes from the authentication terminals based on user identifiers which identify users who use the virtual worlds and for managing the collected attributes and identification information given to the attributes.

A network identity mark issuance/management apparatus according to the present invention comprises collection means for collecting authentication check results from authentication terminals each of which is provided for each of a plurality of virtual worlds existing in a storage device of a computer connected to at least the Internet and authenticates attributes that correspond to users who use the virtual worlds; and

issuance means for issuing identification information to identify the attributes based on the authentication check results collected by the collection means.

A network identity mark issuance/management method according to the present invention comprises a collection step of collecting authentication check results from authentication terminals each of which is provided for each of a plurality of virtual worlds existing in a storage device of a computer connected to at least the Internet and authenticates attributes that correspond to users who use the virtual worlds; and an issuance step of issuing identification information to identify the attributes based on the authentication check results collected.

A storage medium stores a program for a network identity mark issuance/management method according to the present invention which makes a computer execute a collection process for collecting authentication check results from authentication terminals each of which is provided for each of a plurality of virtual worlds existing in a storage device of a computer connected to at least the Internet and authenticates attributes that correspond to users who use the virtual worlds; and an issuance process for issuing identification information to identify the attributes based on the authentication check results collected.

Thus, by issuing identification information certified by a third party, the network identity mark issuance/management system according to the present invention manages personal attributes in virtual worlds constructed in storage devices of host servers (computers) connected to the Internet or the like as well as in the real world, i.e., profile information which can describe individuals, including social status or differentiation from others, qualifications, evaluations by other companies, achievements and evaluations in the organization (community), behavioral history, etc. The identification information certified by a third party is referred to here as a network identity mark (hereinafter abbreviated to NIM).

AN NIM is attached to a user ID (user identifier) used by an individual when accessing a virtual world on the Internet and is certified by a third party (NIM issuance/management company). In this case, more than one NIM may be attached to one user ID. For example, a new ID may be assigned to a combination of a user ID issued by an ISP (Internet Service Provider) and a plurality of NIMs. Alternatively, an existing user ID may be assigned to a combination of a plurality of NIMs. In the former case the user ID issued by an ISP becomes an attribute.

In general, it is possible to display an NIM on a screen of a user terminal or the like by issuing a freeze-frame logo mark which is made tamper-proof using a security protection technology such as an electronic signature.

Examples of NIM-based certifications include a title of Internet community leader certified by a community operator, a good mail user certified by an ISP (e.g., caused no mail trouble in the past three years), a good home page operator certified by an ISP (e.g., drew 10,000 or more visitors in total), a title of opinion leader certified by a famous electronic bulletin-board site operator, a good customer certified by a famous Internet shopping mall managing company, etc.

More specifically, in the NIM issuance/management system according to the present invention, when an applicant sends out information about an application for a desired NIM from a user terminal via a network to the NIM issuance/management apparatus, the NIM issuance/management apparatus issues an authentication request to NIM authentication terminals for examining the applicant, determines whether to accept or reject the applicant based on information about examination results (authentication check results) received from the NIM authentication terminals, and issues and sends out an NIM to the user terminal if the applicant is accepted.

If the examination result information (authentication check results) are attached to the NIM, they can be checked not only via an identification mark, but also via text information by pointing to the NIM with a pointer or opening the NIM when the NIM is used, for example, on a home page.

Alternatively, if the NIM is attached to electronic mail or presented upon entering an electronic bulletin-board site, a shopping mall on the Internet, or the like, credibility of information and credibility in business can readily be assured by the NIM in a virtual world such as the Internet world.

### BRIEF DESCRIPTION OF THE DRAWINGS

FIG. 1 is a block diagram showing a configuration of a network identity mark issuance/management system according to a first embodiment of the present invention;

FIG. 2 is a block diagram showing a configuration example of the NIM issuance/management apparatus shown in FIG. 1;

FIG. 3 is a diagram showing a configuration example of the NIM information DB shown in FIG. 2;

FIG. 4 is a diagram showing an NIM application screen on the user terminal shown in FIG. 1;

FIG. 5 is a diagram showing an NIM display screen on the user terminal shown in FIG. 1;

FIG. 6 is a diagram showing an NIM issuing process carried out by the NIM issuance/management system according to the first embodiment of the present invention;

FIG. 7 is a flowchart showing operation of the NIM issuance/management apparatus shown in FIG. 2;

FIG. 8 is a flowchart showing operation of the NIM issuance/management apparatus shown in FIG. 2;

FIG. 9 is a diagram showing operation of an NIM issuance/management system according to a second embodiment of the present invention;

FIG. 10 is a diagram showing operation of an NIM issuance/management system according to a third embodiment of the present invention; and

FIG. 11 is a diagram showing a configuration example of the NIM information DB shown in FIG. 10.

### DETAILED DESCRIPTION OF THE PREFERRED EMBODIMENTS

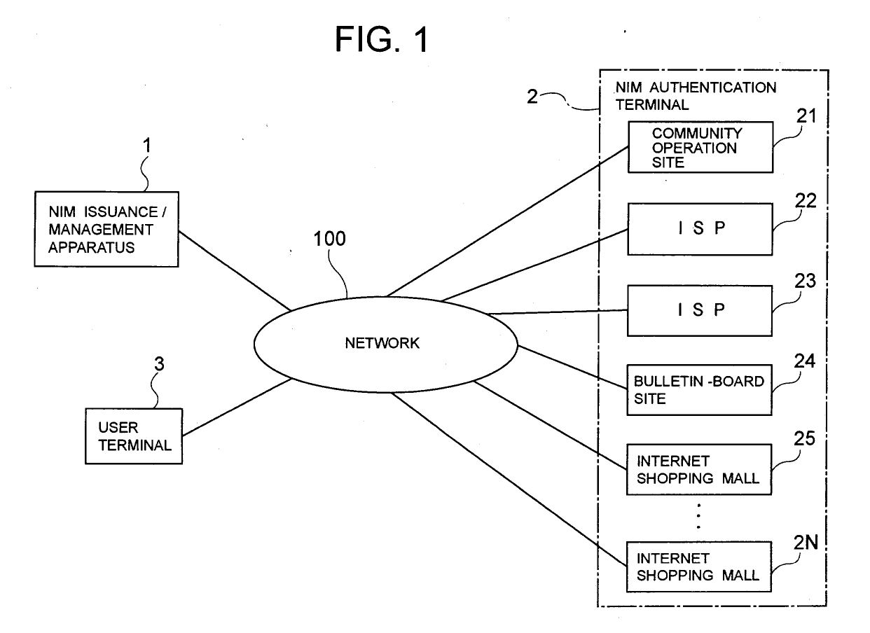

Next, embodiments of the present invention will be described with reference to the drawings. FIG. 1 is a block diagram showing a configuration of a network identity mark issuance/management system according to a first embodiment of the present invention.

By issuing a mark (identification information) certified by a third party, the network identity mark issuance/management system according to the first embodiment of the present invention manages personal attributes in virtual worlds constructed in storage devices of host servers (computers) connected to the Internet or the like as well as in the real world, i.e., profile information which describes individuals, including social status or differentiation from others, qualifications, evaluations by other companies, achievements and evaluations in an organization (community) to which a person belongs, behavioral history, etc. The mark certified by a third party is referred to here as a network identity mark (hereinafter abbreviated to NIM).

Generally, it is possible to display an NIM on a screen of a user terminal or the like by issuing a freeze-frame logo mark which is made tamper-proof using a security protection technology such as an electronic signature. Examples of NIM-based certifications include a title of Internet community leader certified by a community operator, a good mail user certified by an ISP (e.g., caused no mail trouble in the past three years), a good home page operator certified by an ISP (Internet Service Provider) (e.g., drew 10,000 or more visitors in total), a title of opinion leader certified by a famous electronic bulletin-board site operator, a good customer certified by a famous Internet shopping mall managing company, etc.

Referring to FIG. 1, the NIM issuance/management system according to the first embodiment of the present invention comprises an NIM issuance/management apparatus 1, an NIM authentication terminal 2, a user terminal 3, and a network 100, such as the Internet or private lines, interconnecting them.

The NIM issuance/management apparatus 1 consists of an information processing unit such as a server and is used by an NIM issuance/management company. Upon receiving NIM issuance application information sent out by an applicant from a user terminal 3, the NIM issuance/management apparatus 1 is capable of extracting user IDs (user identifiers) registered with the NIM authentication terminal 2 from the NIM issuance application information and sending the appropriate user ID and an authentication request to the NIM authentication terminal 2.

When examination result information is received from the NIM authentication terminal 2 in response to the authentication request and if the examination result is “accept,” the NIM issuance/management apparatus 1 issues an NIM and sends it out to the user terminal 3.

Incidentally, a possible criterion for the NIM issuance/management apparatus 1 to issue an NIM may be that all the items applied for have passed the examination or that at least one of the items applied for has passed the examination. In any case, attaching examination results to an NIM makes it possible to prevent the applicant from falsifying the NIM. It is also possible to display an idle-screen image of the NIM in different colors to allow identification depending on how many applied-for items have been accepted: displaying it in bronze when one applied-for item is accepted, in silver when two applied-for items are accepted, and in gold when three applied-for items are accepted.

Also, by making NIMs tamper-proof using a security protection technology such as an electronic signature, it is possible to enhance credibility of information and credibility in business in virtual worlds such as the Internet world.

The NIM authentication terminal 2 consists of an NIM authentication terminal 21 at a community operation site, NIM authentication terminals 22 and 23 of the ISP (Internet Service Provider), an NIM authentication terminal 24 at an electronic bulletin-board site, and NIM authentication terminals 25 and 2N in Internet shopping malls. Hereinafter these authentication terminals will be referred to collectively as the NIM authentication terminals 2.

Each of these NIM authentication terminals 2 consists of a computer such as an Internet management server or a host server. When a user ID and an authentication request are received from the NIM issuance/management apparatus 1, the NIM authentication terminals 2 carry out an examination (authentication check process) of an application contained in the authentication request and send examination results (authentication check results) to the NIM issuance/management apparatus 1.

The user terminal 3 is an information processing unit such as a personal computer, a PDA (Personal Digital Assistant), or a mobile phone terminal. The user terminal 3 is capable of receiving notification information about qualification for acquiring an NIM from the NIM authentication terminals 2, as well as accessing NIM information provided on the network 100 by the NIM issuance/management apparatus 1 and displaying the mark information on a screen.

Also, the user terminal 3 is capable of preparing the NIM issuance application information, sending out the NIM issuance application information to the NIM issuance/management apparatus 1, receiving NIMs issued by the NIM issuance/management apparatus 1 via the network 100 and storing them, and displaying the NIMs [which may include examination results (authentication check results)] stored in the terminal on a screen.

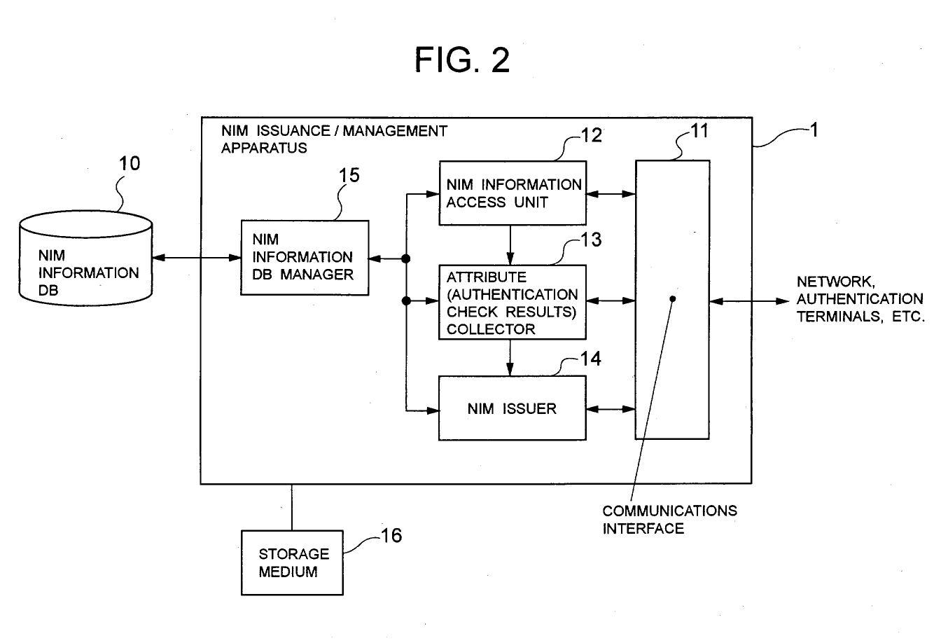

FIG. 2 is a block diagram showing a configuration example of the NIM issuance/management apparatus 1 shown in FIG. 1. In FIG. 2, the NIM issuance/management apparatus 1 is an information processing unit consisting mainly of a personal computer. It comprises a communications interface 11, an NIM information access unit 12, an attribute (authentication check results) collector 13, an NIM issuer 14, an NIM information DB manager 15, and a storage medium 16 and is connected to an NIM information DB (database) 10.

The communications interface 11 is used to connect to the network 100 or the NIM authentication terminals 2 and so forth. The NIM information access unit 12 receives NIM issuance application information and handles access to the NIM information or the like. The attribute (authentication check results) collector 13 makes authentication requests to the NIM authentication terminals 2 and collects attributes [examination results (authentication check results)] which correspond to a user ID from the NIM authentication terminals 2.

The NIM issuer 14 issues and transmits NIMs requested by the user terminal 3. The NIM information DB manager 15 manages registration, changes, and deletion of NIMs and examination results (authentication check results) in the NIM information DB 10. The storage medium 16 stores programs to be executed by a computer. The above components except the communications interface 11 are implemented as the computer executes the programs.

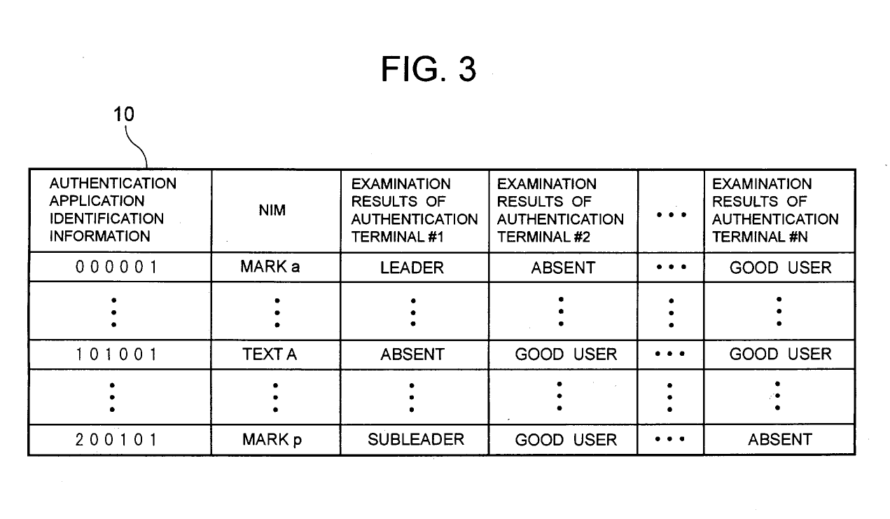

FIG. 3 is a diagram showing a configuration example of the NIM information DB 10 shown in FIG. 2. In FIG. 3, the NIM information DB 10 stores authentication application identification information “000001,” . . . , “101001,” . . . , and “200101” for identifying applicants and applications; NIMs “mark a, ” . . . , “text A,” . . . , and “mark p”; examination results (authentication check results) of authentication terminal #1 “leader,” . . . , “absent,” . . . , and “subleader”; examination results (authentication check results) of authentication terminal #2 “absent,” . . . , and “good user”; and examination results (authentication check results) of authentication terminal #N “good user,” . . . , and “absent” by associating them with each other.

Incidentally, in the above-mentioned configuration example of the NIM information DB 10, a single NIM is issued in accordance with the examination results (authentication check results) produced by a plurality of NIM authentication terminals 2. To issue an NIM in accordance with the examination result (the authentication check result) produced by each of the NIM authentication terminals 2, NIM items can be specified for each of the NIM authentication terminals 2.

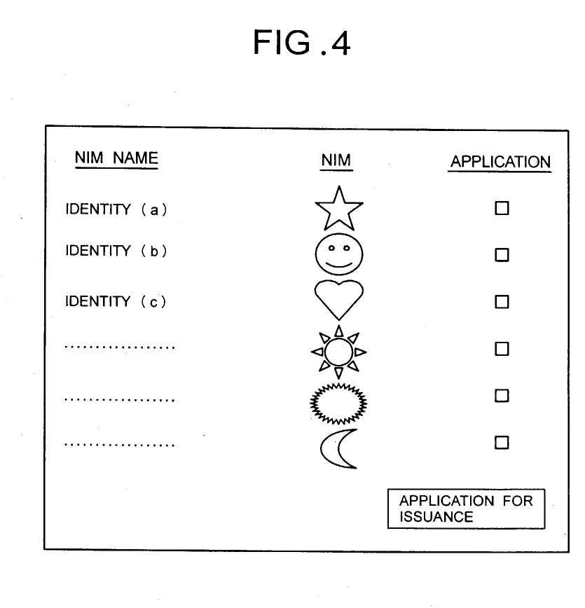

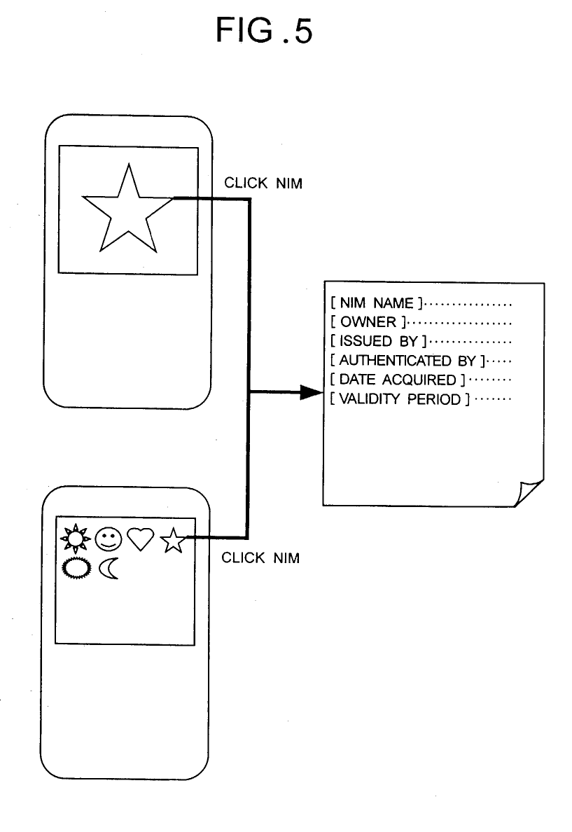

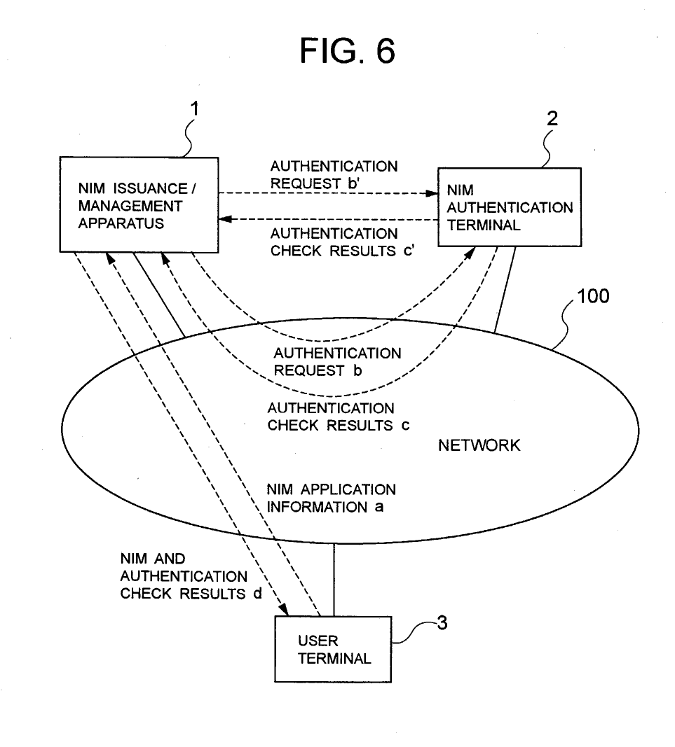

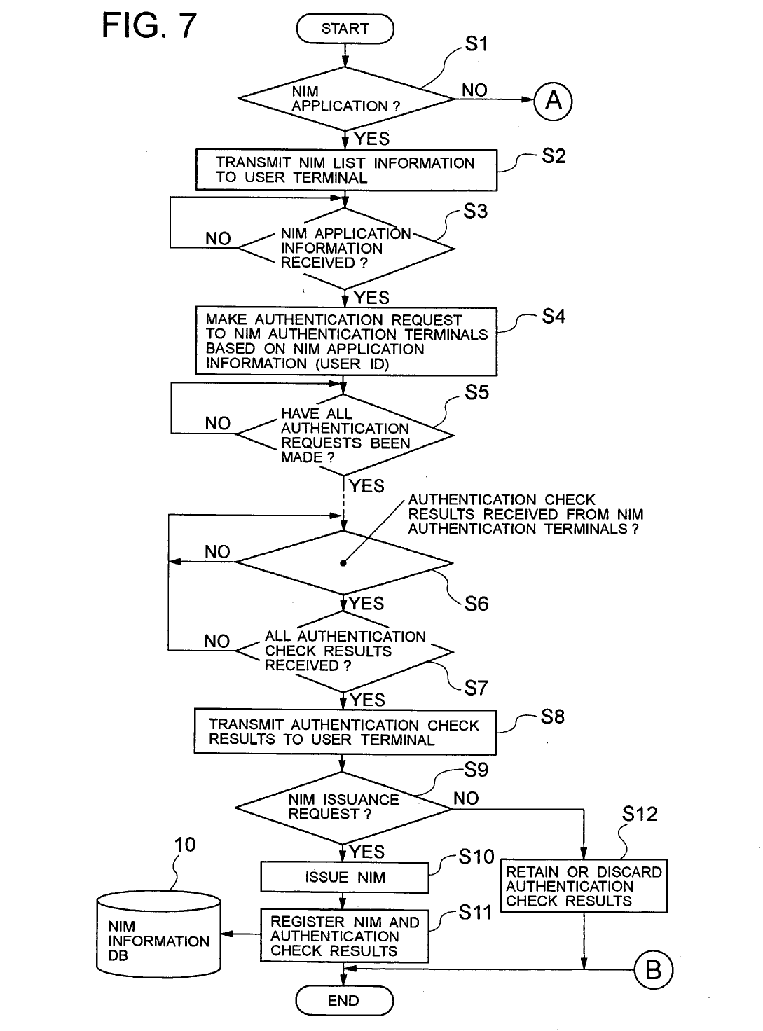

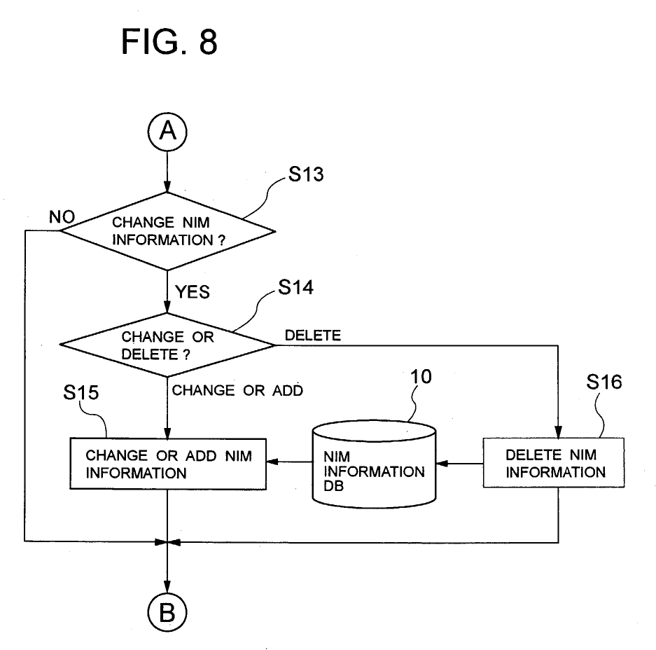

FIG. 4 is a diagram showing an NIM application screen on the user terminal 3 shown in FIG. 1. FIG. 5 is a diagram showing an NIM display screen on the user terminal 3 shown in FIG. 1. FIG. 6 is a diagram showing an NIM issuing process carried out by the NIM issuance/management system according to the first embodiment of the present invention. FIGS. 7 and 8 are flowcharts showing operation of the NIM issuance/management apparatus 1 shown in FIG. 2. The operation of the NIM issuance/management system according to the first embodiment of the present invention will be described with reference to FIGS. 1 to 8.

An applicant accesses an NIM issuance home page on the network 100 from the user terminal 3 and applies for an NIM. Upon receiving the application for the NIM from the user terminal 3 (Step S1 in FIG. 7), the NIM issuance/management apparatus 1 transmits NIM list information to the user terminal 3 (Step S2 in FIG. 7).

The user terminal 3 receives the NIM list information from the NIM issuance/management apparatus 1. Consequently, information about various NIMs is displayed on the user terminal 3 as shown in FIG. 4. By looking at the information about various NIMs displayed on the user terminal 3, the applicant selects a desired NIM and transmits NIM issuance application information to the NIM issuance/management apparatus 1 via the network 100 (see a in FIG. 6).

Upon receiving the NIM issuance application information from the user terminal 3 (Step S3 in FIG. 7), the NIM issuance/management apparatus 1 extracts user IDs registered with the NIM authentication terminals 2 from the NIM issuance application information and sends out the appropriate user ID and an authentication request to the NIM authentication terminals 2 (Step S4 in FIG. 7). The NIM issuance/management apparatus 1 repeats transmitting the authentication request until it finishes making authentication requests to all the NIM authentication terminals 2 indicated in the NIM issuance application information (Steps S4 and S5 in FIG. 7) (see b or b′ in FIG. 6). Here, b′ in FIG. 6 shows a state in which the NIM issuance/management apparatus 1 sends out an authentication request to the NIM authentication terminals 2 by mail, FAX, phone, or the like.

Upon receiving the user ID and the authentication request from the NIM issuance/management apparatus 1, the NIM authentication terminals 2 perform an examination and authentication process using the user ID. The examination and authentication process is carried out by companies or individuals that operate the NIM authentication terminals 2 to examine whether to authorize issuance of the NIM applied for or to examine whether to grant a title or certification applied for. The examination and authentication process may be performed either automatically by computers which constitute the NIM authentication terminals 2 or manually by the companies or individuals that operate the NIM authentication terminals 2.

When examination results are produced, the NIM authentication terminals 2 transmit them to an NIM issuance terminal 20 (see c or c′ in FIG. 6). Here, c in FIG. 6 shows a state in which the computers which constitute the NIM authentication terminals 2 automatically perform the process and transmit the examination results to the NIM issuance/management apparatus 1 via the network 100. On the other hand, c′ in FIG. 6 shows a state in which the companies or individuals that operate the NIM authentication terminals 2 manually perform the process and transmit the examination results to the NIM issuance/management apparatus 1 using a letter, fax, telephone or the like.

Upon receiving examination results from the NIM authentication terminals 2 (Step S6 in FIG. 7), the NIM issuance/management apparatus 1 sends the examination results out to the user terminal 3 (Step S8 in FIG. 7) if the examination results are received from all the NIM authentication terminals 2 to which applications were submitted (Step S7 in FIG. 7).

When the examination result information is received and if the examination results are “accept,” the user terminal 3 transmits an NIM issuance request to the NIM issuance/management apparatus 1. Upon receiving the NIM issuance request from the user terminal 3 (Step S9 in FIG. 7), the NIM issuance/management apparatus 1 issues an NIM to the user terminal 3 (Step S10 in FIG. 7) and registers the NIM and examination results (authentication check results) in the NIM information DB 10 (Step S11 in FIG. 7) (see d in FIG. 6). Consequently, the NIM and examination results (authentication check results) are registered in the NIM information DB 10 together with authentication application identification information created based on the examination result information.

On the other hand, if no NIM issuance request is received from the user terminal 3 within a preset time interval (Step S9 in FIG. 7), the NIM issuance/management apparatus 1 either stores or discards the examination results (authentication check results) received from the NIM authentication terminals 2 (Step S12 in FIG. 7). If the NIM issuance/management apparatus 1 chooses to retain the examination results (authentication check results), retaining them in the NIM information DB 10 will make it possible to respond quickly when the same application is filed in the future.

The user terminal 3 stores the NIM(s) [which may include examination results (authentication check results)] issued by the NIM issuance/management apparatus 1 in its storage device (e.g., non-volatile memory, disk storage medium, or the like). Depending on user settings, the NIM or NIMs stored in the user terminal 3 are displayed on a screen as shown in FIG. 5.

AN NIM is attached to a user ID used by an individual when accessing a virtual world on the Internet and is certified by a third party (NIM issuance/management company). More than one NIM may be attached to one user ID. For example, a new ID may be assigned to a combination of a user ID issued by an ISP and a plurality of NIMs. Alternatively, an existing user ID may be assigned to a combination of NIMs. In the former case the user ID issued by an ISP becomes an attribute.

By clicking an NIM displayed on the screen with a pointer or giving an instruction to open the NIM, it is possible to display the examination results (authentication check results) attached to the NIM such as “NIMName,” “Owner,” “IssuedBy,” “Authenticated By,” “Date Acquired,” and “Validity Period” on the screen. If the examination results (authentication check results) are not attached to the NIM, they can be received from the NIM issuance/management apparatus 1 [e.g., URL (Uniform Resource Locator) of the NIM issuance/management apparatus 1] by clicking the NIM displayed on the screen with a pointer or giving an instruction to open the NIM.

On the other hand, if the purpose of the access request from the user terminal 3 is to change or add NIM information (Steps S13 and S14 in FIG. 8) instead of applying for an NIM (Step S1 in FIG. 7), the NIM issuance/management apparatus 1 changes or adds NIM information in the NIM information DB 10 (Step S15 in FIG. 8). Also, if the purpose of the access request is to delete NIM information (Steps S13 and S14 in FIG. 8), the NIM issuance/management apparatus 1 deletes NIM information in the NIM information DB 10 (Step S16 in FIG. 8).

In this way, according to this embodiment, since the NIM issuance/management apparatus 1 determines whether to issue an NIM according to the examination results (authentication check results) produced by the NIM authentication terminals 2 based on an NIM issuance application information submitted by the user terminal 3, the user of the user terminal 3 can get added value certified by the NIM which corresponds to the user ID in the Internet world (virtual world). This makes it possible to attach profile information which can describe individuals—including past achievements in the Internet community or real world, social status or differentiation from others in the Internet community or real world, qualifications, evaluations by other companies, achievements and evaluations in an organization (community to which a person belongs, behavioral history, etc.—to user IDs which have conventionally been merely anonymous in the eyes of third parties.

Also, as an NIM of the sender is attached to information transmitted over the Internet, it becomes clear what attributes the sender has, making it easy to distinguish between trustworthy and untrustworthy information, and thus assure credibility of information while maintaining anonymity.

Furthermore, when NIMs are made tamper-proof using a security protection technology such as an electronic signature, they can be used for electronic certification or electronic authentication, for example, to grant access rights to limited users in Internet shopping malls. For example, if an NIM can indicate that a user is a good customer in a famous shopping mall A, this user can be treated as a good customer in a shopping mall B as well.

Incidentally, although the NIM issuance/management apparatus 1 is provided separately from the NIM authentication terminals 2 according to this embodiment, this is not restrictive. The NIM authentication terminals 2 may comprise functions of the NIM issuance/management apparatus 1. In that case, however, each of the NIM authentication terminals 2 will issue an NIM and it is difficult to include examination results (authentication check results) of the NIM authentication terminals 2 in a single NIM.

In other words, even if the NIM authentication terminals 2 can exchange their examination results (authentication check results) among themselves, there is the question of what will manage the NIMs and examination results (authentication check results). However, this problem will be solved by making the NIM authentication terminals 2 issue only NIMs and installing a common management device among the NIM authentication terminals 2.

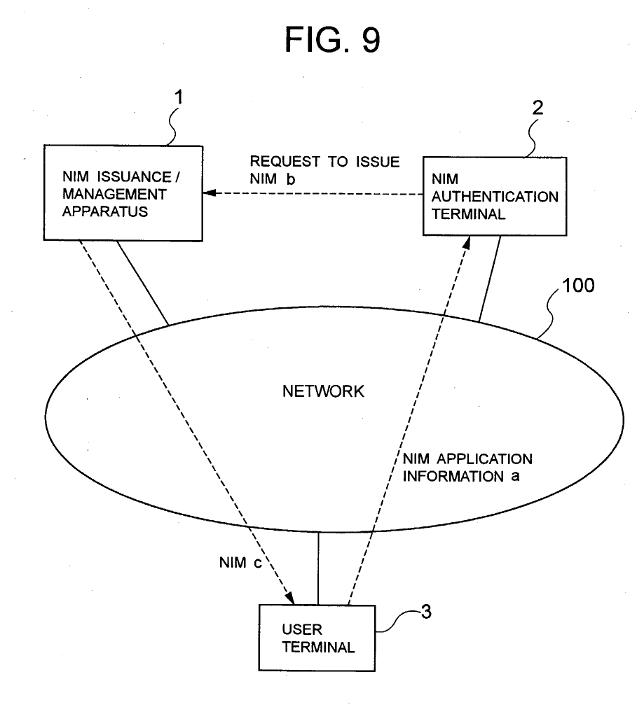

FIG. 9 is a diagram showing operation of an NIM issuance/management system according to a second embodiment of the present invention. Referring to FIG. 9, in the NIM issuance/management system according to the second embodiment of the present invention, the user terminal 3 transmits NIM issuance application information to the NIM authentication terminal 2 (see a in FIG. 9), which then performs an examination and authentication process according to the NIM issuance application information. If the result is “accept,” the NIM authentication terminal 2 requests the NIM issuance/management apparatus 1 to issue an NIM (see b in FIG. 9).

Thus, although according to the first embodiment of the present invention, access to multiple items of NIM information handled by the plurality of NIM authentication terminals 2 is managed collectively by the NIM issuance/management apparatus 1, according to the second embodiment, each of the NIM authentication terminals 2 releases its own NIM information.

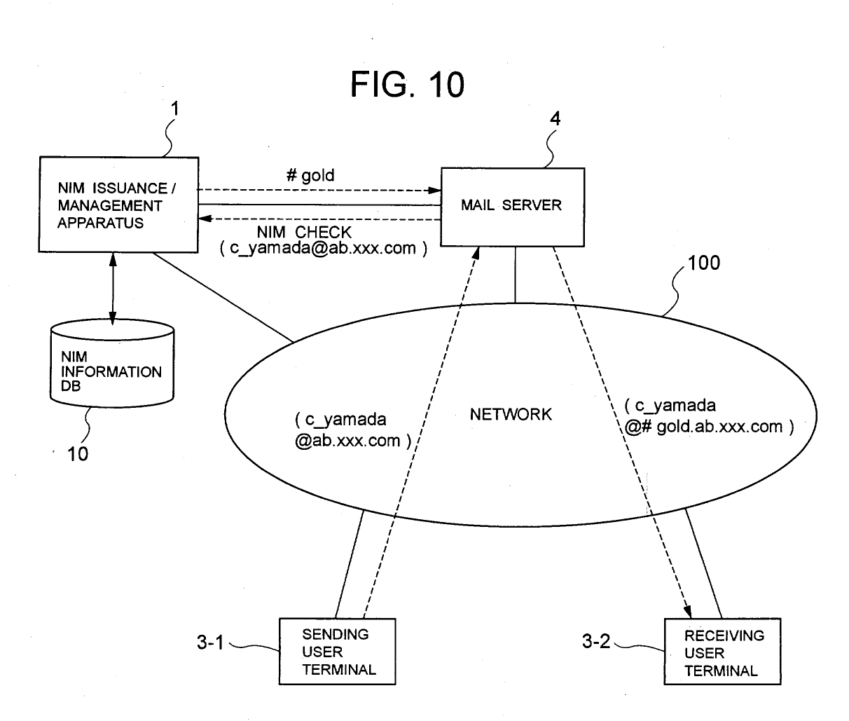

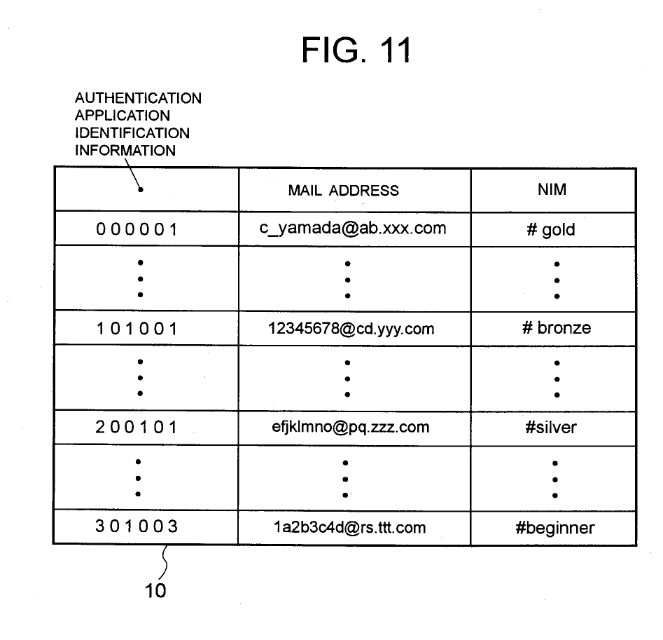

FIG. 10 is a diagram showing operation of an NIM issuance/management system according to a third embodiment of the present invention. FIG. 11 is a diagram showing a configuration example of the NIM information DB 10 shown in FIG. 10. In FIG. 11, the NIM information DB 10 stores authentication application identification information “000001,” . . . , “101001,” . . . , “200101,” . . . , and “301003,”; mail addresses “c_yamada@ab.xxx.com,” . . . , “12345678@cd.yyy.com,” . . . , “efjklmno@pq.zzz.com,” . . . , and “1a2b3c4d@rs.ttt.com”; and NIMs “#gold,” . . . , “#bronze,” . . . , “#silver,” . . . , and “#beginner” either alone or together with the configuration of the NIM information DB 10 shown in FIG. 3.

Referring to FIG. 10, in an NIM issuance/management system according to the third embodiment of the present invention, NIM information managed collectively by the NIM issuance/management apparatus 1 is utilized by a mail server 4 which controls delivery of electronic mail from a sending user terminal 3-1 to a receiving user terminal 3-2.

Electronic mail transmitted by the sending user terminal 3-1 is delivered to the mail server 4 via the network 100, has an NIM added dynamically by the mail server 4 to the sender address contained in its header section, and is transmitted to the receiving user terminal 3-2. In this case, the NIM is text.

Here, based on the sender address, the mail server 4 requests the NIM issuance/management apparatus 1 to check NIM information in the NIM information DB 10. If the sender address is stored in the NIM information DB 10, the NIM issuance/management apparatus 1 returns, to the mail server 4, the NIM—“#gold,” “#bronze,” “#silver,” “#beginner,” or the like—which corresponds to the sender address.

If the NIM “#beginner” is attached to the sender address, in particular, even if the electronic mail is a little ill-mannered, the user of the receiving user terminal 3-2 can understand that the sender of the electronic mail is a beginner and teach manners to the user of the sending user terminal 3-1.

Incidentally, although an NIM is attached to the sender address according to this embodiment, if the NIM is still image data or an NIMation data, it cannot be attached to the sender address and will thus be attached to the electronic mail itself.

Although the mail server 4 and NIM issuance/management apparatus 1 are provided separately according to this embodiment, this is not restrictive. The mail server 4 may comprise the function of the NIM issuance/management apparatus 1 and the NIM information DB 10.

Besides, although an NIM is a mark which itself is represented by an image, text, an animation, or the like, NIMs can incorporate functions which include, but are not limited to, idle screens, shortcuts for URL (Uniform Resource Locator) access on the Internet, electronic authentications, electronic signatures, retention of profile information, electronic business cards, bar codes viewable on a display, application programs, and rights (access, entrance, or other rights).

Furthermore, in addition to the uses described above, NIMs have other possible uses: NIMs may be attached to nicknames of speakers on electronic bulletin boards, NIMs of advertisers (companies, groups, individuals, or the like) may be embedded in banner advertisements, NIMs of designers may be attached to desktop wallpapers or home page resources such as icons, and NIMs of programmers may be attached to help menus of application programs they create.

As described above, by managing attributes corresponding to user identifiers which are given to individual users and identify the users and identification information which is given to the attributes and identifies the attributes in virtual worlds which exist in a storage device of a computer connected to at least the Internet, the present invention readily assures credibility of information and credibility in business in the virtual worlds such as the Internet world.

What is claimed is:

1. A network identity mark issuance/management system, comprising means for managing attributes corresponding to user identifiers which are given to individual users and identify the users, and identification information which is given to the attributes and identifies the attributes, in a virtual world which exists in a storage device of a computer connected to at least the Internet.

2. A network identity mark issuance/management system comprising:
authentication terminals each of which is provided for each of a plurality of virtual worlds existing in a storage device of a computer connected to at least the Internet and authenticates attributes that correspond to users who use said virtual worlds; and
an issuance/management apparatus for collecting said attributes from said authentication terminals based on user identifiers which identify users who use said virtual worlds and for managing the collected attributes and identification information given to the attributes.

3. The network identity mark issuance/management system according to claim 2, wherein said attributes represent profile information of said users.

4. The network identity mark issuance/management system according to claim 2, which gives one or more items of said identification information to said attributes.

5. The network identity mark issuance/management system according to claim 2, which issues said identification information to each of said authentication terminals.

6. The network identity mark issuance/management system according to claim 2, which issues said identification information corresponding to authentication check results produced by a plurality of said authentication terminals.

7. The network identity mark issuance/management system according to claim 2, wherein said identification information contains at least one or more functions from among images, text, an NIMations, idle screens, shortcuts for URL (Uniform Resource Locator) access on the Internet, electronic authentications, electronic signatures, retention of profile information, electronic business cards, bar codes viewable on a display, application programs, and access or entrance rights.

8. The network identity mark issuance/management system according to claim 2, wherein said identification information is attached to either a sender address of electronic mail or said electronic mail itself.

9. The network identity mark issuance/management system according to claim 2, wherein functions of said network identity mark issuance/management apparatus are provided on at least one of said computer, said authentication terminal, and a mail server which manages transmission and reception of electronic mail.

10. A network identity mark issuance/management apparatus comprising:
collection means for collecting authentication check results from authentication terminals each of which is provided for each of a plurality of virtual worlds existing in a storage device of a computer connected to at least the Internet and authenticates attributes that correspond to users who use said virtual worlds; and
issuance means for issuing identification information to identify said attributes based on said authentication check results collected by said collection means.

11. The network identity mark issuance/management apparatus according to claim 10, comprising: storage means for storing said authentication check results and said identification information by associating them with each other; and management means for managing content of said storage means in response to issuance of said identification information by said issuance means and to external instructions.

12. The network identity mark issuance/management apparatus according to claim 10, wherein said attributes represent profile information of said users.

13. The network identity mark issuance/management apparatus according to claim 10, which gives one or more items of said identification information to said attributes.

14. The network identity mark issuance/management apparatus according to claim 10, which issues said identification information to each of said authentication terminals.

15. The network identity mark issuance/management apparatus according to claim 10, which issues said identification information corresponding to authentication check results produced by a plurality of said authentication terminals.

16. The network identity mark issuance/management apparatus according to claim 10, wherein said identification information contains at least one or more functions from among images, text, animations, idle screens, shortcuts for URL (Uniform Resource Locator) access on the Internet, electronic authentications, electronic signatures, retention of profile information, electronic business cards, bar codes viewable on a display, application programs, and access or entrance rights.

17. The network identity mark issuance/management apparatus according to claim 10, wherein said identification information is attached to either a sender address of electronic mail or said electronic mail itself.

18. The network identity mark issuance/management apparatus according to claim 10, which is provided on at least one of said computer, said authentication terminals, and a mail server which manages transmission and reception of electronic mail.

19. A network identity mark issuance/management method comprising: a collection step of collecting authentication check results from authentication terminals each of which is provided for each of virtual worlds existing in a storage device of a computer connected to at least the Internet and authenticates attributes that correspond to users who use said virtual worlds; and an issuance step of issuing identification information to identify said attributes based on said authentication check results collected.

20. The network identity mark issuance/management method according to claim 19, comprising a management step of managing content of storage means which stores said authentication check results and said identification information by associating them with each other in response to issuance of said identification information and to external instructions.

21. The network identity mark issuance/management method according to claim 19, wherein said attributes represent profile information of said users.

22. The network identity mark issuance/management method according to claim 19, wherein one or more items of said identification information are given to said attributes.

23. The network identity mark issuance/management method according to claim 19, wherein said identification information is issued to each of said authentication terminals.

24. The network identity mark issuance/management method according to claim 19, wherein said identification information is issued corresponding to authentication check results produced by a plurality of said authentication terminals.

25. The network identity mark issuance/management method according to claim 19, wherein said identification information contains at least one or more functions from among images, text, an NIMations, idle screens, shortcuts for URL (Uniform Resource Locator) access on the Internet, electronic authentications, electronic signatures, retention of profile information, electronic business cards, bar codes viewable on a display, application programs, and access or entrance rights.

26. The network identity mark issuance/management method according to claim 19, wherein said identification information is attached to either a sender address of electronic mail or said electronic mail itself.

27. A recording medium containing a program for making a computer execute a collection process for collecting authentication check results from authentication terminals each of which is provided for each of a plurality of virtual worlds existing in a storage device of a computer connected to at least the Internet and authenticates attributes that correspond to users who use said virtual worlds; and an issuance process for issuing identification information to identify said attributes based on said authentication check results collected.

28. The recording medium according to claim 27, containing a program for making said computer execute a management process for managing content of storage means which stores said authentication check results and said identification information by associating them with each other in response to issuance of said identification information and to external instructions.

29. The recording medium containing a program according to claim 27, wherein said attributes represent profile information of said users.

30. The recording medium containing a program according to claim 27, wherein one or more items of said identification information are given to said attributes.

31. The recording medium containing a program according to claim 27, wherein said identification information is issued to each of said authentication terminals.

32. The recording medium containing a program according to claim 27, wherein said identification information is issued corresponding to authentication check results produced by a plurality of said authentication terminals.

33. The recording medium containing a program according to claim 27, wherein said identification information contains at least one or more functions from among images, text, an NIMations, idle screens, shortcuts for URL (Uniform Resource Locator) access on the Internet, electronic authentications, electronic signatures, retention of profile information, electronic business cards, bar codes viewable on a display, application programs, and access or entrance rights.

34. The recording medium containing a program according to claim 27, wherein said identification information is attached to either a sender address of electronic mail or said electronic mail itself.
